(19) United States
(12) Patent Application Publication
(10) Pub. No.: US 2026/0234417 A1
(43) Pub. Date: Aug. 13, 2026

(54) RAPID CURING WATERPROOFING COMPOSITION AND METHOD

(71) Applicant: Laticrete International, Inc., Bethany, CT (US)

(72) Inventors: Jack W. Hayford, III, Arlington, TX (US); Brandon A. Serraile, Aubrey, TX (US); Aaron Hogan, Arlington, TX (US)

(21) Appl. No.: 19/051,755

(22) Filed: Feb. 12, 2025

(51) Int. Cl. C09D 5/16

(52) U.S. Cl. CPC C09D 5/1693; C09D 5/1662; C09D 5/1668; C09D 5/1687

(57) ABSTRACT

A two-part waterproof coating composition including a base composition having at least one latex-based binder, wherein the base composition has a viscosity of at least 1,000 centipoise, and a water-based activating composition having at least one acid, wherein the waterproof coating composition is cured upon combining the base composition with the water-based activating composition. A method of providing a waterproof coating to a substrate includes applying a base composition to the substrate, wherein the base composition has a latex-based binder, and curing the base composition on the substrate by sequentially applying a water-based activating composition having at least one acid, wherein the waterproof coating is cured within about 10 seconds to about 120 minutes after the activating composition is applied.

### FIELD OF THE TECHNOLOGY

The present technology relates to a waterproofing composition and method for use in the construction industry. In particular, the present technology relates to a two-component waterproofing composition and method of use that includes a latex based coating and an activating spray composition which rapidly cures the latex based coating upon sequential application.

### BACKGROUND OF THE INVENTION

Waterproofing membranes are commonly used to isolate portions of structures from water exposure adjacent to areas that will be exposed to water. These membranes typically come in the form of a water-based coating which is applied to a horizontal or vertical surface in one or more coats. In many cases, the application of the waterproofing membrane will be followed by the application of tile. Whether the application requires a second coat or the application of tile, it is advantageous if the curing of the membrane can be accelerated so that the time required to complete the job is reduced. This reduction in labor time also reduces the cost of the job. In outdoor applications, the speed of curing is also important because it is undesirable for an uncured material to be exposed to elements, such as water, as it may negatively impact the physical characteristics of the cured coating.

It is an object of the present invention to provide a waterproofing membrane coating that can be rapidly cured to reduce the job cost and minimize exposure to elements.

It is also an object of the present technology to provide a waterproofing membrane coating that has sufficient or superior strength, adhesion and waterproofing characteristics.

### BRIEF SUMMARY OF THE INVENTION

To achieve at least the above-stated objectives, the present technology provides a two-component water-based coating is described along with a method to promote rapid curing. The coating system is composed of a primary coating element and an activating spray which allows for the system to cure rapidly. The first coating element can have a viscosity of 1,000 to 2,000,000 centipoise. The second component is an aqueous solution which can be supplied in liquid form, or alternatively as a powder to which water is added to make the aqueous solution before application to the coating element.

The first coating element is applied to the surface being coated by any appropriate means including rolling, brushing, or spreading. Subsequently, the second component is sprayed onto the coated surface. The first component or the second component may contain colored indicators to show where the spray has been applied.

Other features and advantages of the present invention will become apparent from the following more detailed description, which illustrates, by way of example, the principle of the invention.

### DETAILED DESCRIPTION OF THE INVENTION

It is noted that, as used in the specification and the claims, the singular form “a,” “an,” and “the” comprises plural referents unless the context clearly indicates otherwise. For example, reference to a component in the singular is intended to comprise a plurality of components.

The term “about” is to be construed as modifying a term or value such that it is not an absolute. This term will be defined by the circumstances. This includes, at the very least, the degree of expected experimental error, technique error and instrument error for a given technique used to measure a value. In general, this term used in connection with a numerical value throughout the specification and the claims denotes an interval of accuracy, familiar and acceptable to a person skilled in the art. In general, such interval of accuracy is +10%. Thus, “about ten” means 9 to 11. All numbers in this description indicating amounts, ratios of materials, physical properties of materials, and/or use are to be understood as modified by the word “about,” except as otherwise explicitly indicated.

The term “comprising” is synonymous with “including,” “having,” “containing,” or “characterized by.” These terms are inclusive and open-ended and do not exclude additional, unrecited elements or method steps.

The term “essentially free” means here less than 5 wt. %, preferably less than 3 wt. % and in particular less than 1 wt. %, based on the total weight of the composition.

As used herein, the terms “latex” or “latex emulsion” refer to an aqueous emulsion of an acrylic, styrene acrylic, vinyl acrylic, vinyl chloride, styrene butadiene, butadiene acrylate, methacrylate, or polyurethane polymer or copolymer.

Provided herein are two-part aqueous coating compositions. The two-part aqueous coating compositions may include a first coating component and a second coating component. The two coating components are applied to a surface sequentially to form a rapid set coating.

When the first coating component comprises a first latex emulsion and a second latex emulsion, the first latex emulsion and the second latex emulsion may be present in the first coating component in varying amounts so as to provide a resultant coating with the desired properties for a particular application. For example, the first latex may be present in the first coating component in an amount of at least about 10% by weight (e.g., at least 20% by weight, at least 30% by weight, at least 40% by weight, at least 50% by weight, at least 60% by weight, at least 70% by weight, at least 80% by weight, or at least 90% by weight), based on the total latex solids content of the first coating component. In some embodiments, the first latex may be present in the first coating component in an amount of about 90% or less by weight (e.g., 90% or less by weight, 80% or less by weight, 70% or less by weight, 60% or less by weight, 50% or less by weight, 40% or less by weight, 30% or less by weight, or 20% or less by weight), based on the total latex solids content of the first coating component.

The first latex emulsion may be present in the first coating component in an amount ranging from any of the minimum values described above to any of the maximum values described above. For example, the first latex emulsion may be present in the first coating component in an amount of about 10%-90% by weight (e.g., 10%-50% or 20%-40% by weight), based on the total latex solids content of the first coating component. In some embodiments, the first latex component is present in an amount of about 10% to about 70% by weight of the first coating component, or in an amount of about 15% to about 65%, or about 20% to about 60%.

The second latex emulsion may be present in the first coating component in an the in an amount of at least about 10% by weight (e.g., at least 20% by weight, at least 30% by weight, at least 40% by weight, at least 50% by weight, at least 60% by weight, at least 70% by weight, at least 80% by weight, or at least 90% by weight), based on the total latex solids content of the first coating component. In some embodiments, the second latex emulsion may be present in the first coating component in an amount of about 90% or less by weight (e.g., 90% or less by weight, 80% or less by weight, 70% or less by weight, 60% or less by weight, 50% or less by weight, 40% or less by weight, 30% or less by weight, or 20% or less by weight), based on the total latex solids content of the first coating component. In some embodiments, the second polymer may be present in the first coating component in an amount of about 10%-90% by weight (e.g., 50%-90% or 60%-80% by weight), based on the total latex solids content of the first coating component. In some embodiments, the second latex component is present in an amount of about 0% to about 80% by weight of the first coating component, or in an amount of about 0.1% to about 50%, or in an amount of about 0.5% to about 30%.

In some embodiments, the first latex and the second latex (when present) may be mixed to form an aqueous dispersion. The aqueous dispersion may be used to form the first coating component. The first coating component may further include other ingredients, including, but not limited to, a surfactant, a filler, a pigment, a dispersing agent, a thickener, a defoamer, a surfactant, a biocide, a coalescing agent, a flame retardant, a stabilizer, a curing agent, a flow agent, a leveling agent, a wetting and spreading agent, a hardener, a pH modifying agent, a solvent or co-solvent, a plasticizer, an adhesion promoting agent, an anti-freezing agent, a flame retardant and intumescent additive, a cleanability additive, or combinations thereof. These ingredients may include any such ingredients known in the art.

One or more surfactants may be included in the aqueous dispersions to improve certain properties of the dispersions, including particle stability. Suitable surfactants include nonionic surfactants and anionic surfactants. Examples of nonionic surfactants include alkylphenoxy polyethoxyethanols having alkyl groups of about 7 to about 18 carbon atoms and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. For example, oleic acid, sodium laureth sulfate, and alkylbenzene sulfonic acid or sulfonate surfactants may be used. Examples of commercially available surfactants include TRITON X-405, available from Dow Chemical Company. In general, the concentration of surfactants employed may be from about 0.01 to 5%, based on the total amount of the monomers to be polymerized. One or more surfactants may act as defoamer agents, leveling agents, and emulsifiers.

Suitable dispersing agents include, but are not limited to, polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. Dispersants may be provided in an amount from about 0.02% to about 2% by weight based on the total weight of the first coating component composition.

Defoamers serve to minimize frothing during mixing and/or application of the coating component. Suitable defoamers include organic defoamers such as mineral oils, silicone oils, and silica-based defoamers. Exemplary defoamers include, but are not limited to, BY K®-035, a mineral oil and silane-based blend, available from BY K USA Inc., and the TEGO® series of defoamers, available from Evonik Industries. In general, the concentration of defoamers may be from about 0.02% to about 2% by weight (based on the total weight of the first coating component).

The first coating component may also include a pH sensitive hydrogel to aid in controlling the water which is released when the activating spray causes the breakdown of the latex emulsion. Exemplary pH sensitive hydrogels include, but are not limited to hydrogels produced in accordance with the article “Development and evaluation of pH-sensitive biodegradable ternary blended hydrogel films (chitosan/guar gum/PVP) for drug delivery application,” by Zunaira Huma Ghauri, Atif Islam, Muhammad Abdul Qadir, Nafisa Gull, Bilal Haider, Rafi Ullah Khan, & Tabinda Riaz. The concentration of pH sensitive hydrogel may be from about 0.5% to about 5.0% by weight (based on the total weight of the first coating component).

In some embodiments, the first coating component may further include at least one functional filler. The filler has a function that improves one or more properties of the coating composition, such as function and performance characteristics. Suitable fillers may include, but are not limited to, calcium carbonate, kaolin, barium sulfate, dolomite, clay, wollastonite, silica, mica, talc, polyester fibers, and combinations thereof. The mean particle sizes of the filler may range from about 5 microns to about 100 microns. Preferably, the particle size of the functional filler is at least 5 microns. The filler is preferably present in the first coating component in an amount from about 5% to about 50% by weight, more preferably from about 10% to about 40% by weight (i.e., the weight percentage of the filler based on the total weight of the first coating component).

The first coating component may further include one or more pigments. Examples of suitable pigments include, but are not limited to, metal oxides, such as titanium dioxide, aluminum oxide, magnesium oxide, zinc oxide, iron oxide, or combinations thereof. The pigments are preferably present in the first coating component in an amount from about 0.1% to about 10% by weight, more preferably from about 1% to about 5% by weight (based on the total weight of the first coating component). The pigments function as colorants to achieve a desired color of the coating composition. In addition, the pigments function as color indicators. Preferably, one or more acid-sensitive color-changing agents may be included in the first coating component and/or the second coating component. These agents will change color upon contact with the acid agents contained in the second coating component, as described below, to indicate to a user where the second coating component has been applied such that the user can ensure consistent application of the second coating component to the first coating component. Examples of acid-sensitive color-changing agents include, but are not limited to, Congo Red or Litmus.

The first coating component may include one or more thickeners or rheology modifiers that function to control viscosity, improve application properties, and prevent sagging or settling of the coating composition. Examples of suitable thickeners include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. Thickeners may be included in an amount from about 0.05% to about 10%, or about 0.1% to about 6% (based on the total weight of the first coating component).

Suitable coalescents, which aid in film formation during drying, include glycol ethers, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof. Coalescents may be added in an amount from about 0.05% to about 10%, or about 0.1% to about 6% (based on the total weight of the first coating component).

Examples of suitable pH modifying agents include, but are not limited to, bases such as sodium hydroxide, potassium hydroxide, amino alcohols, monoethanolamine (MEA), diethanolamine (DEA), 2-(2-aminoethoxy) ethanol, diisopropanolamine (DIPA), 1-amino-2-propanol (AMP), ammonia, and combinations thereof. pH modifying agents may be included in an amount from about 0.01% to about 1%, or about 0.1% to about 0.5% (based on the total weight of the first coating component).

Suitable biocides may be incorporated to inhibit the growth of bacteria and other microbes in the coating composition during storage. Suitable biocides may also include biocides that inhibit the growth of mold, mildew, and spores thereof in the coating. A ny suitable biocides known to those skilled in the art may be used, including but not limited to, biocides based on products based on methylisothiazolinone; 1,2-benzisothiazolin-3-one; diiodomethyl-p-tolyl sulfone, or isothiazolinone. One or more biocides are preferably present in the first coating component in an amount from about 0.01% to about 1% by weight, more preferably from about 0.05% to about 0.5% by weight (i.e., the weight percentage of the filler based on the total weight of the first coating component).

Exemplary co-solvents, humectants, and anti-freezing agents may include, but are not limited to, ethylene glycol, propylene glycol, diethylene glycol, and combinations thereof.

In some embodiments, the first coating component may be essentially free of or free of microspheres and/or expanded glass particles.

The volume solids percentage of the first coating component may be at least about 40%. For example, the volume solids percentage of the first coating component may be at least 45%, at least 50%, at least 55%, at least 60%, at least 65%, at least 70%, or at least 75%.

The weight solids percentage of the first coating component may be at least about 50%. For example, the weight solids percentage of the first coating component may be at least 55%, at least 60%, at least 65%, at least 70%, at least 75%, or at least 80%.

The second coating component may comprise an activating spray. For example, the second coating component may be an aqueous solution or suspension of a material or materials that precipitate solids or semi-solids from solution, such as polymeric particles from a latex dispersion.

The second coating component may comprise an effective amount of the activating agent, such that when the second coating component is sprayed onto the first coating component, the addition of the activating agent decreases the stability of the dispersion of one or more polymers in the first coating component, causing the coating to set more quickly. The activating agent may be one or more acids, including but not limited to, citric acid, tartaric acid, ascorbic acid, formic acid, weak hydrochloric acid, or combinations thereof. The strength or concentration of the acid or acids may be adjusted to accelerate the action of the activating spray such that the set time of the coating composition is shortened and to eliminate cracking of the set coating. Additionally, the strength or concentration of the acid(s) may be adjusted to allow a thicker layer of the first coating component to cure thoroughly through the thickness of the coating. The degree of acceleration of the cure will be influenced by the acid strength and the nature of the substrate. In some embodiments, the second coating component includes citric acid. In additional embodiments, the second coating component includes tartaric acid. In some embodiments, the second coating component is free of or essentially free of phosphoric acid. The one or more acids may be provided in an amount from about 1% to about 40%, or from about 10% to about 20%, or from 11% to 13% by weight of the second coating component.

The second coating component may also include a buffer system. The buffer system functions to interact with the acid components to yield desired characteristics of the coating system, such as to provide correct pH in the system, to provide buffering effect, and to maintain pH higher than about 2 so that waste material is not considered hazardous waste. The buffer system may include one or more acids and/or one or more salts. A ratio of the acid component to the buffer system component may be from about 10.87:1 to about 2.71:1, or from about 8.15:1 to about 3.71:1.

The second coating component may optionally include additional ingredients, including but not limited to, surfactants, thickeners, pigments and/or color changing indicators and solvents. Surfactants are provided to assist in wetting the powder material when mixed with water and may be provided in an amount from about 0.1% to bout 0.3%, or from about 0.1% to about 0.2%. Thickeners are provided to control viscosity of the second coating component and may be included in an amount from about 0.01% to about 0.25%, or from about 0.04% to about 0.1%. Color changing indicators may be acid-sensitive or pH indicators that function to change color when the second coating component comes into contact with the first coating component to indicate the areas of contact. Color changing indicators may be anthrocyanin based indicators, among others, and may be present in an amount from about 0.05% to about 0.4%, or from about 0.1% to about 0.3%. Solvents, such as water, are added to a powder composition to provide an aqueous second coating component composition. Water or other solvents may be added in an amount from about 40% to about 95%, or from about 80% to about 90%.

In some embodiments, a weight ratio of the dry weight of the activating agent, such as acid agent, in the second coating component to the dry weight of polymer, such as latex-based polymer, in the first coating component is at least 1:16. The weight ratio of polymer is based on the total dry weight of polymer in the first component and is the total dry weight of the first latex and the second latex in cases where the first coating component includes two latexes. In some embodiments, the weight ratio can be 2:16 or greater, 3:16 or greater, 5:16 or greater, or 30:16 or greater, or 36:16 or greater.

The first coating component may also include a pH sensitive foaming agent, also referred to as a blowing agent, which may be activated by the activating agent container in the second coating component, or another activating agent. The blowing agent provides a foaming action within the first coating component that acts to seal pinholes in the coating. Examples of foaming/blowing agents include, but are not limited to, sodium carbonate, sodium bicarbonate, ammonium bicarbonate, sodium hydrogen citrate, and combinations thereof. The foaming/blowing agents may be provided in an amount from about 1% to about 8% by weight of the second coating component composition.

Other embodiments of the coating system may include an epoxy-amine component where the second coating component includes a sorbitol-based glycidyl ether resin. This resin may be a non-bisphenol derived resin. The sorbitol resin may crosslink with dormant amino functional substituents within the latex membrane. The sorbitol resin may be water soluble at >=20% at 70 degrees F. and preferably water soluble>=60%. The sorbitol resin may have one or more epoxy functional groups with an epoxy equivalent weight (EEW) from about 25-2000, preferably about 125-165. The resin may have a boiling point>100 degrees C.

The amine component may be incorporated into the first coating component composition. The amine substituents may include functionalized silanes or a water-soluble diamine. The water-soluble diamine is water soluble at least >=30% at 70 degrees F. and preferably soluble at >=60% at 70 degrees F. The amino substituent may have a structure of at least one primary amino groups, and may be aliphatic linear, branched, or cyclic in nature. The amine-based material may have an amine hydrogen equivalent weight (AHEW) between about 10 to about 600, and preferably between about 20 and about 100. The amine may be stable at room temperature and in the presence of latex resin.

The epoxy-amine components may serve as an additional curing mechanism within the two-component system. The waterborne epoxy-amine 2K mechanism may be activated only when the second coating component is used on the pre-applied first coating component. One epoxy-amine component may lay dormant within the first coating component while the second coating component may contain the second epoxy-amine component. This additional curing mechanism may increase the adhesion of the coating composition that is too difficult to stick to substrates such as plywood and PVC. The curing mechanism of the epoxy-amine system is a fast-reacting combination, which does not delay the curing of the second coating component to the first coating component.

The first coating component and the second coating component may be provided as separate compositions, which may be provided as a kit or purchased separately. In some embodiments, the second coating component composition may be provided in a powder form, which is then mixed with water or another solvent to provide a sprayable composition for use. The first coating component and the second coating component are preferably applied sequentially to a substrate and allowed to dry to form a dried coating. The substrate may be, for example, a PVC pipe, concrete, brick, mortar, asphalt, a spray polyurethane foam surface, a metal, a thermoplastic polyolefin surface, an ethylene-propylene diene monomer (EPDM) surface, a modified bitumen surface, a wall, a storage tank, and another coating surface (in the case of recoating applications). In some embodiments, the surface may be an architectural surface. In some embodiments, the surface may be a substantially horizontal surface such as a roof surface. In some embodiments, the surface may be a substantially vertical surface such as a wall. In some embodiments, the coating composition may be applied to floors to provide moisture control to provide crack-bridging properties.

The first coating component may be applied to a surface by any suitable coating technique, including rolling, brushing, or spreading. The second component may be applied sequentially by spraying. The first coating component and the second coating component may be applied in a single coat sequentially as described, or in multiple sequential coats, each coat having the first coating component applied and subsequently sprayed with the second component (e.g., in two coats or in three coats) as required for a particular application. Generally, the coating composition is allowed to dry under ambient conditions. However, in certain embodiments, the coating composition may be dried, for example, by heating and/or by circulating air over the coating.

In some embodiments, the first coating component may be applied at a viscosity of at least about 1000 cPs (e.g., at least 2000 cPs, at least 5000 cPs, at least 10,000 cPs, at least 100,000 cPs, at least 1,000,000 cPs, at least 2,000,000 cPs,) measured using a Brookfield RV viscometer with T bar spindle Helipath A at 20° C.

The thickness of the resultant coatings may vary depending upon the application of the coating. For example, the coating can have a dry thickness of at least 5 mils (e.g., at least 10 mils, at least 20 mils, at least 30 mils, at least 40 mils, or at least 50 mils at least 60 mils, at least 80 mils, or at least 100 mils). In some instances, the coating has a dry thickness of less than 100 mils (e.g., less than 90 mils, less than 80 mils, less than 75 mils, less than 60 mils, less than 50 mils, less than 40 mils, less than 20 mils, or less than 10 mils). In some embodiments, the coating has a dry thickness of between 5 mils and 100 mils. In certain embodiments, the coating has a dry thickness of between 10 mils and 40 mils.

The tensile strength of coatings formed from the first coating component and the second coating component described herein can be measured according to ASTM D-2370. The coatings display tensile strength after a drying period of at least 14 days, as measured according to ASTM D-2370, of at least 140 psi (e.g., at least 150 psi, at least 160 psi, at least 170 psi, at least 180 psi, at least 190 psi, at least 200 psi, at least 210 psi, at least 220 psi, or at least 225 psi).

Further advantageous configurations of the invention are evident from the exemplary embodiments.

### Example 1

An exemplary first coating component composition in accordance with the present technology is described below. The composition may be made by mixing together the following components to obtain a viscous composition having a viscosity of at least 1000 cPs:

| Component | Range, wt. % |
|---|---|
| First latex polymer¹ | 10-70 |
| Second latex polymer² | 0-80 |
| Pigments³ | 0.1-10 |
| Preservatives/anti-microbials⁴ | 0.02-2 |
| Defoamer⁵ | 0.02-2 |
| Leveling and dispersing agent⁶ | 0.02-2 |
| Emulsifier⁷ | 0.05-2 |
| Co-binder⁸ | 0-3 |
| Filler⁹ | 3-60 |
| Rheology additive¹⁰ | 0.05-6 |
| Coalescent¹¹ | 0.05-6 |
| Water | 1-50 |
| Other Additives¹² | q.s. |
| Total | 100 |

¹Acrylic, styrene acrylic, vinyl acrylic, vinyl chloride, styrene butadiene, butadiene acrylate, methacrylate, or polyurethane polymer or copolymer, such as styrene butadiene copolymer latex.
²Acrylic, styrene acrylic, vinyl acrylic, vinyl chloride, styrene butadiene, butadiene acrylate, methacrylate, or polyurethane polymer or copolymer, such as butadiene acrylate copolymer latex.
³Titanium dioxide, iron oxide, zinc oxide, ultramarine blue, and the like.
⁴Isothiazolinone derivative biocides, diiodomethyl p-tolyl sulfone, and the like.
⁵Silicone-based antifoam agent, such as polydimethylsiloxane (PDMS), and the like.
⁶Polyacid dispersants and hydrophobic copolymer dispersants, and the like.
⁷Carboxymethyl cellulose, sodium lauryl sulfate and the like.
⁸Organo-silanes and the like.
⁹Calcium carbonate, micas, polyester fibers, and the like.
¹⁰Hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and the like.
¹¹Glycol ether and the like.
¹²pH adjusting agents, humectants, freeze-thaw control agents, and the like.

### Example 2

Another exemplary first coating component composition in accordance with the present technology is described below. The composition may be made by mixing together the following components to obtain a viscous composition having a viscosity of at least 1000 cPs:

| Component | Range, wt. % |
|---|---|
| First latex polymer¹ | 40-60 |
| Second latex polymer² | 0.1-5 |
| Pigments³ | 0.2-5 |
| Preservatives/anti-microbials⁴ | 0.02-2 |
| Defoamer⁵ | 0.05-1 |
| Leveling and dispersing agent⁶ | 0.02-2 |
| Emulsifier⁷ | 0.05-2 |
| Co-binder⁸ | 0-3 |
| Filler⁹ | 20-40 |
| Rheology additive¹⁰ | 0.05-6 |
| Coalescent¹¹ | 0.1-2 |
| Water | 5-20 |
| Other Additives¹² | q.s. |
| Total | 100 |

¹Acrylic, styrene acrylic, vinyl acrylic, vinyl chloride, styrene butadiene, butadiene acrylate, methacrylate, or polyurethane polymer or copolymer, such as styrene butadiene copolymer latex.
²Acrylic, styrene acrylic, vinyl acrylic, vinyl chloride, styrene butadiene, butadiene acrylate, methacrylate, or polyurethane polymer or copolymer, such as butadiene acrylate copolymer latex.
³Titanium dioxide, iron oxide, zinc oxide, ultramarine blue, and the like.
⁴Isothiazolinone derivative biocides, diiodomethyl p-tolyl sulfone, and the like.
⁵Silicone-based antifoam agent, such as polydimethylsiloxane (PDMS), and the like.
⁶Polyacid dispersants and hydrophobic copolymer dispersants, and the like.
⁷Carboxymethyl cellulose, sodium lauryl sulfate and the like.
⁸Organo-silanes and the like.
⁹Calcium carbonate, micas, polyester fibers, and the like.
¹⁰Hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and the like.
¹¹Glycol ether and the like.
¹²pH adjusting agents, humectants, freeze-thaw control agents, and the like.

### Example 3

An exemplary second coating component composition in accordance with the present technology was made by mixing together the following components in dry form, and adding water to obtain an aqueous composition:

| Component | Range, wt. % |
|---|---|
| Activating agent (acid)¹ | 5-40 |
| Co-acid² | 0.1-0.3 |
| Buffer³ | 1.75-4 |
| Surfactant⁴ | 0.1-0.3 |
| Thickener⁵ | 0.01-0.25 |
| Color Indicator⁶ | 0.05-0.4 |
| Water | 40-92 |
| Other Modifiers⁷ | q.s. |

¹Citric acid or the like
²Tartaric acid or the like
³Salt buffer, such as sodium L-tartrate dibasic dihydrate or the like
⁴Gemini surfactant, e.g., bis-quaternary ammonium compounds, sulfonate-based gemini surfactants, carboxylate-based surfactants, polyethylene glycol-based surfactants, betaines or sulfobetaines, or the like
⁵Diutan gum or the like
⁶Anthrocyanin based indicator or the like
⁷Other optional components, including but not limited to thickeners and silanes.

The dry components in the composition are mixed with water to obtain a sprayable second coating component composition.

### Example 4

Another exemplary second coating component composition in accordance with the present technology was made by mixing together the following components in dry form, and adding water to obtain an aqueous composition:

| Component | Range, wt. % |
|---|---|
| Activating agent (acid)¹ | 10-20 |
| Co-acid² | 0.15-0.2 |
| Buffer³ | 3.3-3.8 |
| Surfactant⁴ | 0.1-0.2 |
| Thickener⁵ | 0.04-0.1 |
| Color Indicator⁶ | 0.1-0.3 |
| Water | 80-90 |
| Other Modifiers⁷ | q.s. |

¹Citric acid or the like
²Tartaric acid or the like
³Salt buffer, such as sodium L-tartrate dibasic dihydrate or the like
⁴Gemini surfactant, e.g., bis-quaternary ammonium compounds, sulfonate-based gemini surfactants, carboxylate-based surfactants, polyethylene glycol-based surfactants, betaines or sulfobetaines, or the like
⁵Diutan gum or the like
⁶Anthrocyanin based indicator or the like
⁷Other optional components, including but not limited to thickeners and silanes.

The dry components in the composition are mixed with water to obtain a sprayable second coating component composition.

### Example 5

Breaking strength testing were performed on various compositions in accordance with ASTM D751, Procedure B. The coating composition of Example 2 as used as “control.” “10% active” refers to 10% concentration citric acid solution that was sprayed onto to the coating composition of Example 2. “Mix #2” refers to a second coating component utilizing only the acid and co-acid of Example 4. “Mix #3” refers to a second coating component utilizing only the acid, co-acid and buffer of Example 4.

The testing results are summarized in Table 1 below:

TABLE 1

| vertical orientation | psi |
|---|---|
| CONTROL | 184.77 |
| 10% Active | 197.56 |
| 10% Active | 198.13 |
| Mix #2 | 202.72 |
| Mix #3 | 213.38 |
| Mix #3 | 234.59 |

As demonstrated by the testing results in Table 1, activating the rapid cure of the first coating composition of Example 2 by utilizing the second coating compositions of Mix #2 and Mix #3 did not lead to any reduction in breaking strength as compared to the composition of Example 2, but rather boosted the breaking strength.

### Example 6

Pull off adhesion testing were performed on various compositions in accordance with ASTM D 4541. The coating composition of Example 2 was used as “control.” “40% active” refers to 40% concentration citric acid solution that was sprayed onto to the coating composition of Example 2.

The testing results are summarized in Table 2 below:

TABLE 2

| | Substrate | | | | |
|---|---|---|---|---|---|
| | | | Galvanized | | Cement |
| Sample | Copper | Aluminum | Steel | Drywall | board |
| Control | | | | | |
| 1 | 39.0 | 30.0 | 54.5 | 10.0 | 30.0 |
| 2 | 43.9 | 34.7 | 28.9 | 12.0 | 25.2 |
| 3 | 35.8 | 19.6 | 36.5 | 14.0 | 27.5 |
| 4 | 49.8 | 29.5 | 25.0 | 14.0 | 25.1 |
| | 42.1 | 28.5 | 36.2 | 12.5 | 27.0 |
| 40% Active | | | | | |
| 1 | 25.0 | 29.5 | 47.5 | 10.0 | 27.6 |
| 2 | 36.0 | 23.2 | 33.9 | 12.0 | 26.5 |
| 3 | — | 60.3 | 50.7 | 10.0 | 33.1 |
| 4 | 28.4 | 27.3 | 46.7 | 16.0 | 28.5 |
| | 37.5 | 31.4 | 40.0 | 12.3 | 27.8 |

The testing indicates that the fast-curing coating composition with an acid activator spray applied performs just as well at adhesion strength to various substrates (i.e., copper, aluminum, galvanized steel, drywall, and cement board) as the slow-drying coating compositions.

### Example 7

Hydrostatic pressure resistance testing was performed on various compositions in accordance with ASTM D4068 Annex 2.>=48 hours indicates PASS and <48 hours indicates FAIL. The coating composition of Example 2 was used as “control.” “10.2% active” refers to 10.2% concentration citric acid solution that was sprayed onto to the coating composition of Example 2. The testing results are summarized in Table 3 below:

TABLE 3
10.2%

| | 24 hours | 48 hours | 72 hours | >72 hours |
|---|---|---|---|---|
| Active | | | | |
| 1 | PASS | PASS | PASS | PASS |
| 2 | PASS | PASS | PASS | PASS |
| 3 | PASS | PASS | PASS | PASS |
| CONTROL | | | | |
| 1 | PASS | PASS | FAIL | X |
| 2 | PASS | PASS | PASS | PASS |
| 3 | PASS | PASS | PASS | PASS |

As demonstrated by the testing results in Table 3, the inventive coating composition with the acid activator spray applied exhibits satisfactory hydrostatic pressure resistance, indicating its suitable waterproofing qualities.

### Example 8

Shear strength testing were performed on various compositions in accordance with ANSI 118.10 5.3, ANSI 118.10 5.4 and ANSI 118.10 5.5 (ASTM C 482-1996). Shear strength to ceramic tile and cement mortar was measured. The coating composition of Example 2 was used as “control.” “10% active” refers to 10% concentration citric acid solution applied to the coating component composition of Example 2. A satisfactory performance requirement for this testing is average shear strength greater than 50 psi.

The testing results are summarized in Table 4 below:

TABLE 4

| | ANSI 118.10 | |
|---|---|---|
| | 5.3 and 5.4 | |
| | Shear strength to | ANSI 118.10 5.5 |
| | ceramic tile and | Shear strength to |
| | cement mortar | ceramic tile and |
| | 14 d (7 d cure + | cement mortar |
| | 7 d cure immersion) | 28 d cure |
| 10% Active | | |
| Spray and | 83 +/− 39 | 150 +/− 26 |
| let stand | | |
| Spray and | 130 +/− 10 | 207 +/− 2 |
| wipe | | |
| Control | | |
| no spray | 123 +/− 28 | 201 +/− 48 |

The tests showed that the coating compositions with the acid activator spray applied perform satisfactory with respect to the shear strength of the coating when applied to ceramic tile and cement mortar after certain curing periods.

### Example 9

Crack resistance testing was performed on various compositions in accordance with ANSI A 118.12 Section 5.4. The first coating component composition as per Example 2 was tested by itself (Sample 1) and then the first coating component composition as per Example 2 was combined with the second coating component composition as per Example 4 (Sample 2). PASS for Standard Performance indicates that the tile failure occurs after 1/16 inch gap opening, but before ⅛ inch gap opening. PASS for High Performance indicates that the tile failure does not occur by ⅛ inch specimen gap opening.

The testing results are summarized in Table 5 below:

TABLE 5

Crack Resistance ANSI
A 118.12.5.4

| | Standard | High |
|---|---|---|
| | Performance | Performance |
| Sample 1 | Pass | Pass |
| Sample 2 | Pass | Pass |

The tests showed that the coating compositions of the present invention perform satisfactory with respect to the crack resistance.

Although the technology has been described and illustrated with respect to exemplary embodiments thereof, it should be understood by those skilled in the art that the foregoing and various other changes, omissions and additions may be made therein and thereto, without parting from the spirit and scope of the present technology. It should also be understood that features described and illustrated in reference to one embodiment may be employed in other embodiments as appropriate.

It should be noted that the invention in its broader aspects is not limited to the specific details, representative compositions, methods, and processes, and illustrative examples described in connection with the preferred embodiments and preferred methods. Modifications and equivalents will be apparent to practitioners skilled in this art and are encompassed within the spirit and scope of the appended claims.

1. A two-part waterproof coating composition, comprising:
a base composition comprising at least one latex-based binder, wherein the base composition has a viscosity of at least 1,000 centipoise, and
a water-based activating composition comprising at least one acid,
wherein the waterproof coating composition is cured upon combing the base composition with the water-based activating composition.

2. The coating composition according to claim 1, wherein the base composition has a pH between about 7 to about 12.

3. The coating composition according to claim 1, wherein the water-based activating composition has a pH above about 2.

4. The coating composition according to claim 1, wherein at least one of the base composition and the water-based activating composition comprises a color changing indicator that indicates where the water-based activating composition has been applied.

5. The coating composition according to claim 1, wherein the base composition further comprises one or more functional fillers having a particle size of about 5 microns or more.

6. The coating composition according to claim 1, wherein a dry weight of the at least one acid in the water-based activating composition and a dry weight of the at least one latex-based binder in the base composition is in a ratio of at least about 1:16.

7. The coating composition according to claim 1, wherein the base composition further comprises a blowing agent activated by the water-based activating composition to provide a foaming action within the base composition.

8. The coating composition according to claim 1, wherein the base composition further comprises at least one reactive silane to provide adhesion properties to the coating composition.

9. The coating composition according to claim 1, wherein the at least one latex binder is selected from an acrylic, styrene acrylic, vinyl acrylic, vinyl chloride, styrene butadiene, butadiene acrylate, methacrylate, polyurethane polymer or copolymer, and mixtures thereof.

10. The coating composition according to claim 1, further comprising a second latex binder selected from an acrylic, styrene acrylic, vinyl acrylic, vinyl chloride, styrene butadiene, butadiene acrylate, methacrylate, polyurethane polymer or copolymer, and mixtures thereof.

11. The coating composition according to claim 1, wherein a total solids content of the base composition is about 50% or more.

12. The coating composition according to claim 1, wherein the at least one acid is selected from citric acid, tartaric acid, and mixtures thereof.

13. The coating composition according to claim 1, wherein the base composition further comprises:
at least one solvent, and
at least one epoxy.

14. The coating composition according to claim 1, wherein the water-based activating composition further comprises a buffer system, wherein the buffer system comprises at least one salt.

15. A method of providing a waterproof coating to a substrate, comprising the steps of:
applying a base composition to the substrate, wherein the base composition comprises a latex-based binder, and
curing the base composition on the substrate by sequentially applying a water-based activating composition comprising at least one acid,
wherein the waterproof coating is cured within about 10 seconds to about 120 minutes after the activating composition is applied.

16. The method according to claim 15, wherein the base composition has a viscosity of about 5,000 centipoise to about 2,000,000 centipoise and is applied to the substrate by rolling or brushing.

17. The method according to claim 12, wherein the water-based activating composition is applied by spraying.

18. The method according to claim 12, wherein the waterproof coating is cured within about 5 to about 60 minutes after the activating spray is applied.

19. The method according to claim 12, further comprising the step of providing a powder activating composition and mixing the powder activating composition with water to obtain the water-based activating composition before application to the base composition.

20. A two-part waterproof coating composition, comprising:
a base composition comprising a latex-based binder selected from an acrylic, styrene acrylic, vinyl acrylic, vinyl chloride, styrene butadiene, butadiene acrylate, methacrylate, polyurethane polymer or copolymer, and mixtures thereof, wherein the base composition has a viscosity of about 5,000 centipoise to about 2,000,000 centipoise; and
a water-based activating composition comprising at least one acid;
wherein at least one of the base composition and the water-based activating composition comprises a color changing indicator that indicates where the water-based activating composition has been applied; and
wherein the waterproof coating composition is cured upon combing the base composition with the water-based activating composition.
